(19) United States
(12) Patent Application Publication
(10) Pub. No.: US 2007/0007821 A1
(43) Pub. Date: Jan. 11, 2007

(54) Untethered power supply of electronic devices

(76) Inventor: Nazzareno Rossetti, Danville, CA (US)

Correspondence Address: SIDLEY AUSTIN BROWN & WOOD LLP, 555 CALIFORNIA STREET, SUITE 2000, SAN FRANCISCO, CA, 94104-1715, US

(21) Appl. No.: 11/175,763

(22) Filed: Jul. 6, 2005

(51) Int. Cl. H02J 3/02

(52) U.S. Cl. 307/22

(57) ABSTRACT

An electrical power transmission system includes an electric power transmitter for a wireless transmission of electric power in a confined space, and an electric power receiver to receive the transmitted electric power in the confined space and to transform the received electric power to power electric devices, wherein the system is configured to operate substantially free of exposure hazards. The electric power receiver may include a rectifier to rectify the receiver electric power, a storage device to store the rectified electric power, and a power controller to produce regulated outputs, wherein the electric power transmitter is configured to transmit electric power with a power flux corresponding to Federal Health Regulations. Some electric power receivers include a feedback transmitter to transmit a feedback signal to the electric power transmitter, wherein the electric power transmitter includes a feedback receiver, configured to receive the transmitted feedback signal from the electric power receiver.

### BACKGROUND

1. Field of Invention

The present invention relates to power distribution systems and more particularly to wireless electric power distribution systems.

2. Description of Related Art

Transmitting electric power without wires has long been a dream for applications of all kinds. In early experiments, power was transmitted over kilometers of distance by Tesla's laboratory. In some more recent proposals even a Moon based electric power collection and supply system has been proposed. In other industrial demonstrations, an airplane has been flown over an antenna array, which beamed up energy to operate the electric motor of the plane.

Simultaneously, it has been a distinct trend in the consumer electronics industry to reduce the number of wires, which are needed for the operations of the consumer electronic devices and for computational devices. Wireless communication is now omnipresent around us, from mobile cell phones through Blackberry personal email access to infrared communication between Palm Pilots.

However, all these advances aim to reduce the number of signal wires, i.e. wires which carry the electronic signals. Therefore, even if carried to its perfection, this program does not eliminate the last wire, needed for the operation of these devices: the electric power cord. Only eliminating the electric power cord will create a truly mobile communications world, extending to all classes of wireless consumer electronic products.

### SUMMARY

Briefly and generally, embodiments of the invention include an electrical power transmission system, including an electric power transmitter, configured for a wireless transmission of electric power in a confined space, and an electric power receiver, configured to receive the transmitted electric power in the confined space and to transform the received electric power to power electric devices, wherein the system is configured to operate substantially free of exposure hazards.

Embodiments also include an electrical power transmission system, including an electric power transmitter, configured for a wireless transmission of electric power in a confined space, and an electric power receiver, configured to receive the transmitted electric power in the confined space, the electric power receiver including: a rectifier, configured to rectify the receiver electric power, a storage device, coupled to the rectifier, configured to store the rectified electric power, and a power controller, coupled to the storage device, configured to produce one or more regulated outputs, wherein the electric power transmitter is configured to transmit electric power with a power flux corresponding to Federal Health Regulations.

Embodiments also include an electrical power transmission system, including an electric power transmitter, configured for a wireless transmission of electric power in a confined space, and an electric power receiver, configured to receive the transmitted electric power in the confined space, the electric power receiver including, a rectifier, configured to rectify the receiver electric power, a storage device, coupled to the rectifier, configured to store the rectified electric power, a power controller, configured to produce one or more regulated outputs, and a feedback transmitter, configured to transmit a feedback signal to the electric power transmitter, wherein the electric power transmitter includes a feedback receiver, configured to receive the transmitted feedback signal from the electric power receiver.

Embodiments also include a method of transmitting electric power, the method including the steps of: transmitting electric power wirelessly in a confined space with a power flux corresponding to Federal Health Regulations, receiving the transmitted electric power, and transforming the received electric power into a form suitable for powering electric devices.

### BRIEF DESCRIPTION OF DRAWINGS

For a more complete understanding of the present invention and for further features and advantages, reference is now made to the following description taken in conjunction with the accompanying drawings.

FIG. 1 illustrates a block diagram of an electric power transmission system, according to an embodiment of the invention.

FIG. 2 illustrates the dimensions of the antennae in the power transmission system, according to an embodiment of the invention.

FIG. 3 illustrates an implementation of the electric power transmission system, according to an embodiment of the invention.

FIG. 4 illustrates an implementation of the electric power receiver according to an embodiment of the invention.

FIG. 5 illustrates an implementation of the electric power transmitter according to an embodiment of the invention.

FIG. 6 illustrates an implementation of the electric power receiver according to an embodiment of the invention.

### DETAILED DESCRIPTION

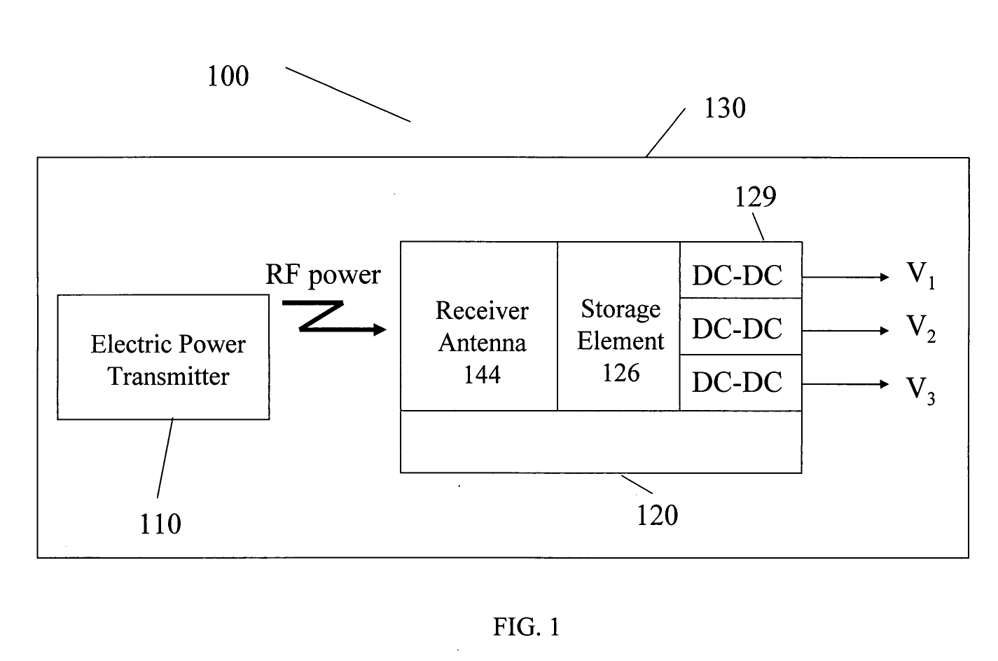

Embodiments of the present invention and their advantages are best understood by referring to FIGS. 1-6 of the drawings. Like numerals are used for like and corresponding parts of the various figures.

FIG. 1 illustrates a block diagram of an electric power transmission system 100. System 100 includes an electric power transmitter 110 and an electric power receiver 120. Electric power transmitter 110 can include a radio frequency (RF) power source 111. Electric power transmitter 110 is configured to transmit electric power in a wireless manner inside a confined space 130. For example, the transmission can be by radiation through air and confined space 130 can be an office building, a residence, a manufacturing plant, or a sporting field.

Operating in a limited space raises specific problems, since the electric power is transmitted where people can be hazardously exposed to the transmission. Therefore, electric power transmission system 100 is configured to operate substantially free of exposure hazards.

In some embodiments, system 100 operates free of exposure hazards by transmitting electric power with a power flux, which corresponds to the applicable Federal Health Regulations. For example, in embodiments the power flux does not exceed 5 mW/cm², to comply with presently applicable Federal Health Regulations.

In other embodiments, system 100 operates free of exposure hazards by using active power transmission management. Active power transmission management includes reducing or interrupting the transmission of the electric power, if the power transmission poses a hazard. Exposure hazards may include a person walking into the path of transmission, or a portion of the transmitted power being reflected away from the intended target of electric power receiver 120 to an unintended target. The exposure hazard can be detected by either electric power transmitter 110 or electric power receiver 120, as described below in detail.

Electric power receiver 120 is capable of receiving the transmitted electric power inside confined space 130. Electric power receiver 120 transforms the received electric power to power electric devices. For example, electric power receiver 120 can transform the received electric power into a DC power, which is then coupled into office devices, consumer electronic devices, manufacturing machines, or display devices through wires and cables.

In an embodiment an office has one or more electric power transmitters 110, for example, located on the ceiling, radiating RF power to one or more electric power receivers 120. Electric power receivers 120 can be connected to office devices, such as computers, data processing devices, and office administration devices.

In another embodiment a living room of a residence has an electric power transmitter 110, which is radiating RF power to one or more electric power receivers 120. Electric power receivers 120 can be coupled to domestic appliances, such as a TV, a computer, and an entertainment center.

In yet other embodiments, an industrial plant or a manufacturing hall utilizes electric power transmission system 100 to transmit power without cables to individual electric machines.

In the above embodiments the distance between electric power transmitter 110 and electric power receiver 120 can be between 1 m and 100 m inside confined space 130.

In an embodiment the total power transmitted by system 100 can be in the range of 1 W-100 kW.

In some embodiments, electric power transmitter 110 and electric power receiver 120 are built to transmit the electric power with a frequency in the range of 1 GHz-100 GHz. Some embodiments operate in the frequency range of 2.4 GHz-2.5 GHz, the band which was designated by the Federal Communications Commission for “industrial, scientific, and medical” uses.

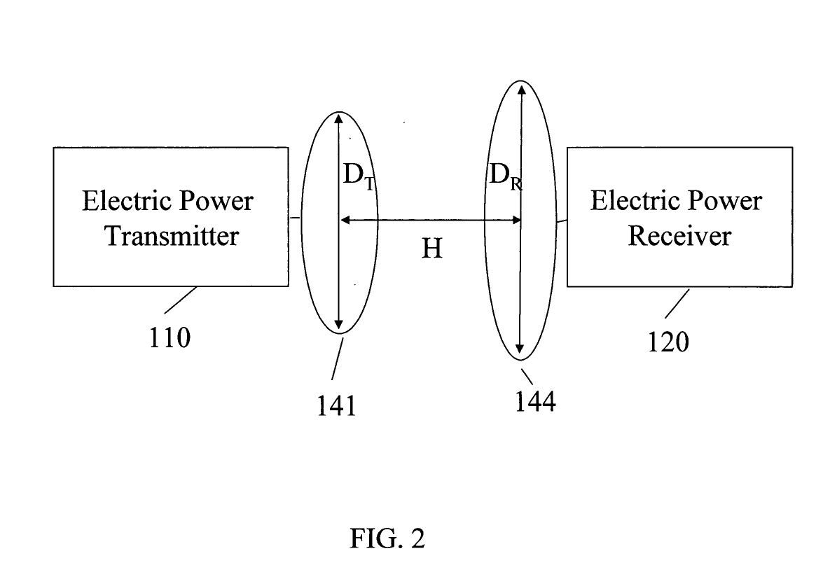

FIG. 2 illustrates an embodiment of system 100. In this embodiment electric power transmitter 110 includes a transmitter antenna 141, which has a transmitter antenna diameter D_{T}. Electric power receiver 120 includes a receiver antenna 144, which has a receiver antenna diameter D_{R}. In some embodiments D_{T} and D_{R} are related to a distance H of transmitter antenna 141 and receiver antenna 144, and to a wavelength of the transmission λ.

In some embodiments, the product D_{T}*D_{R} corresponds to the product H*λ. In some embodiments this relationship is given by Equation (1):
D_{T}*D_{R}=2k*H*λ (1)

Here k is a constant, and its value is of the order of one, e.g. 1.4. In other embodiments the diameters of the antennae are determined by other relationships.

In some examples, a big electronic appliance can be operated wirelessly across a room by the following parameters according to the above Equation (1). If the distance H=5 m and the diameter of both transmitter antenna 141 and receiver antenna 144 is D=2 m, then a power of about 150 W can be transmitted at about 1 GHz frequency, while abiding the 5 mW/cm² power flux limit. Receiver antenna 144 may be positioned e.g. behind a flat screen TV.

In some examples, a small electronic appliance can be operated wirelessly across a room by the following parameters according to the above Equation (1). If the distance H=5 m and the diameter of both transmitter antenna 141 and receiver antenna 144 is D=0.3 m, then a power of about 3.5 W can be transmitted at about 47 GHz frequency, while abiding the 5 mW/cm² power flux limit.

In some embodiments electric power transmitter 110 emits a directed beam and electric power receiver 120 is positioned to receive the emitted directed beam in the far field region. For example, a directed beam can be generated by using a parabolic transmitter antenna 141 and placing RF source 111 into the focal point of the parabolic antenna. The far field region is defined as the region which is at a distance d from transmitter 110 larger than the wavelength of the transmitted beam: d>λ. For radio frequency transmissions in the 1 GHz-100 GHz range the corresponding wavelength λ is in the range of 30 cm-0.3 cm, so the far field region is at the distance, which is more than 30 cm-0.3 cm away from transmitter antenna 141.

In some embodiments, the directed beam can be a coherent directed beam. The coherent directed beam can be a coherent microwave beam (maser) or an infrared laser beam. In some embodiments, the coherent beam is broadened by optics to reduce the power flux. In these embodiments electric power receiver 120 may include a focusing optics, narrowing the received coherent directed beam.

FIG. 1 illustrates an embodiment, where receiver antenna 144 in electric power receiver 120 is a rectifying antenna 123. Rectifying antenna 123 is capable of receiving the transmitted electric power and rectifying the received electric power. There are a large number of designs known for rectifying antennae and most of them can be included in embodiments of electric power receiver 120. In some references a rectifying antenna is referred to as an RF-DC rectifying antenna or a rectenna.

In some embodiments, electric power receiver 120 further includes a storage device (or storage element) 126, coupled to rectenna 123. A function of storage device 126 is to store the rectified electric power, received from rectenna 123. In embodiments storage device 126 can include one or more batteries and one or more capacitors.

In some embodiments, electric power receiver 120 further includes one or more DC-to-DC converters 129, coupled to storage device 126. DC-DC converters are configured to convert the stored electric power of storage device 126 into a DC electric voltage. For example, in the shown embodiment there are 3 DC-DC converters 129-1, 129-2, and 129-3, which output DC voltages at output voltage terminals V1, V2 and V3. These voltages then can be coupled into various circuits of an electric appliance or into office and domestic electric appliances and devices, among others. For example, V1, V2, V3 can provide internal voltages on a motherboard of an appliance.

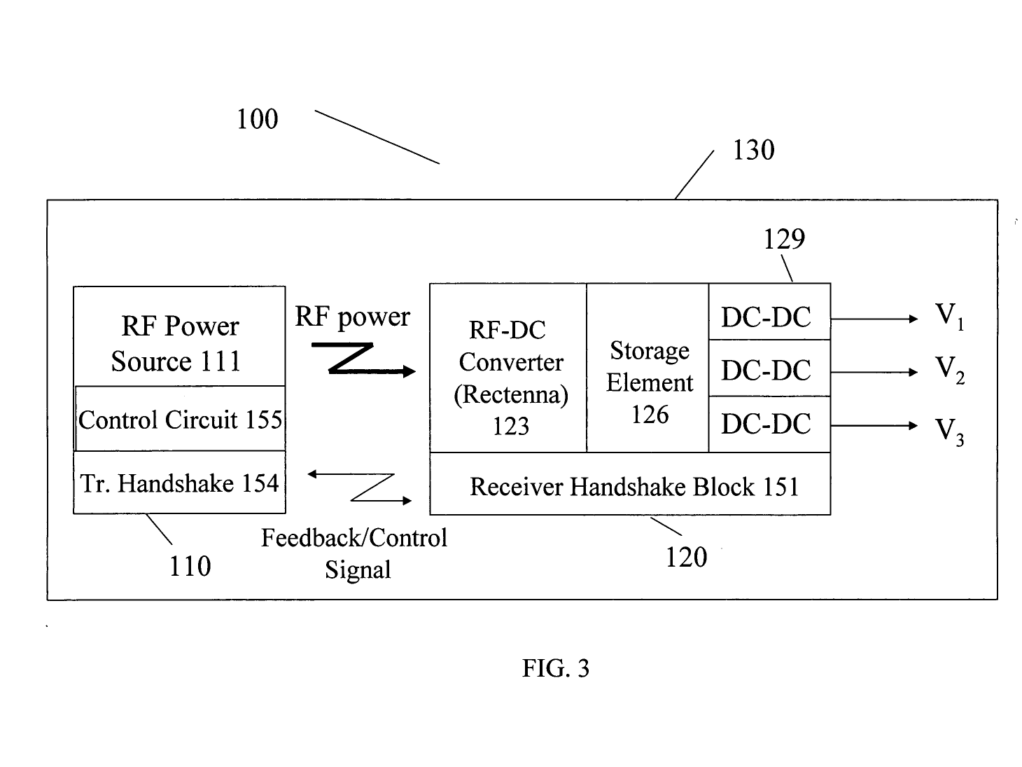

FIG. 3 illustrates an embodiment of system 100. In addition to the elements of FIG. 1, this embodiment includes a receiver handshake block 151 in electric power receiver 120, which is configured to transmit a feedback signal toward electric power transmitter 110. Further, electric power transmitter 110 includes a transmitter handshake block 154, configured to receive the transmitted feedback signal and report it to a control circuit 155 of electric power transmitter 110.

In embodiments, the feedback signal indicates to electric power transmitter 110 that an operating condition of electric power receiver 120 has changed. There are many possible ways such a change in an operating condition can occur.

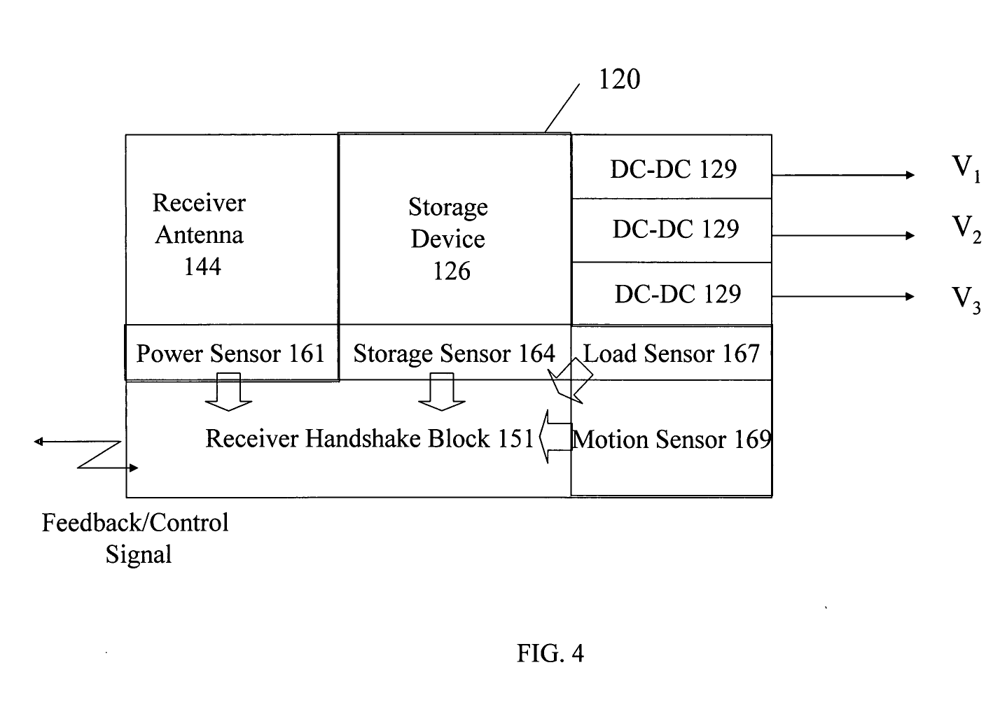

FIG. 4 illustrates embodiments, which sense a change in an operating condition. In an example, electric power receiver 120 includes a power sensor 161, coupled to receiver antenna 144 or rectenna 123. If power sensor 161 senses a reduction of the transmitted electric power below a preset level, then a reduction or turning off of the transmitted power may become necessary. For example, it may be that a human being walked into the path of the transmitted beam, causing the loss of power level. In order to avoid damage to the human in the beam, in this case system 100 may reduce or switch off the transmitted electric power. Or if an object is temporarily blocking the transmission, then it would be wasteful and again possibly dangerous to continue the transmission.

Therefore, in embodiments, power sensor 161 induces receiver handshake block 151 to transmit a “reduced power” feedback signal to transmitter handshake block 154 in response to the sensed reduced transmitted power. Transmitter handshake block 154 reports the received “reduced power” feedback signal to control circuit 155 of electric power transmitter 110. Electric power transmitter 110 in response may reduce or interrupt the electric power transmission.

Since the obstacle in the transmission path may obstruct the path of the feedback signal as well, receiver handshake block 151 may emit the signal not as a directed beam but as a wide angle emission, which is sensed by transmitter handshake block 154 after a reflection.

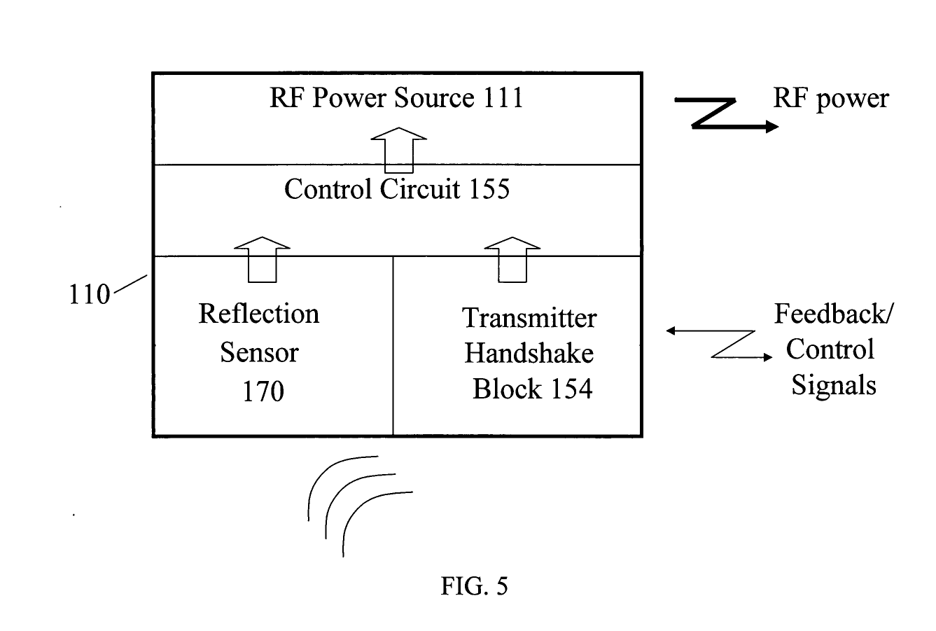

FIG. 5 illustrates embodiments, which address this issue. In these embodiments, electric power transmitter 110 includes an interrupt sensor 170. Interrupt sensor 170 can be a reflection sensor, configured to sense if a portion of the transmitted electric power is reflected from an obstacle. Upon sensing a reflected portion of the transmitted power, reflection sensor reports to control circuit 155. In response to the report, control circuit may instruct RF power source 111 to reduce or interrupt the transmission of electric power.

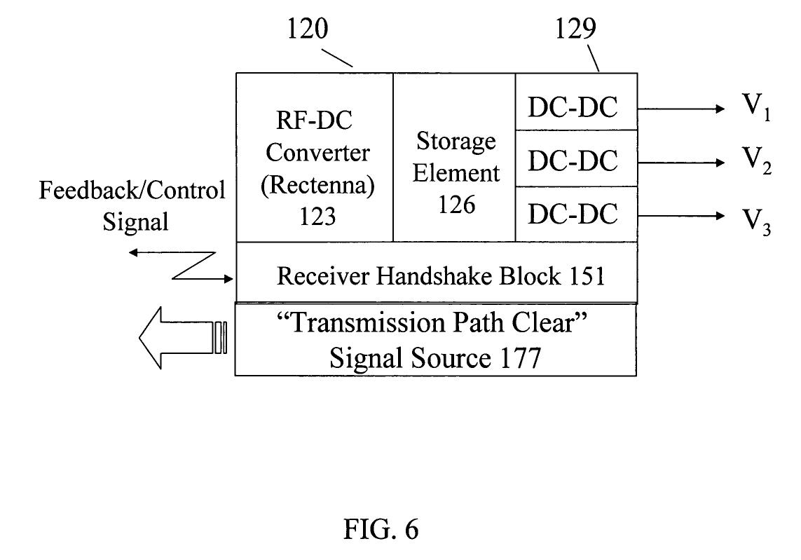

FIG. 6 illustrates that in other embodiments, electric power receiver 120 includes a “transmission path clear” signal source 177. “Transmission path clear” signal source 177 emits a “transmission path clear” signal in the direction of interrupt sensor 170. The “transmission path clear” signal can be, e.g., an infrared signal. In these embodiments the presence of an obstacle in the transmission path is sensed by interrupt sensor 170 not receiving the “transmission path clear” signal. When interrupt sensor 170 stops sensing the “transmission path clear” signal, interrupt sensor 170 reports to control circuit 155. In response to the report, control circuit may instruct RF power source 111 to reduce or interrupt the transmission of electric power.

Returning to FIG. 4, in embodiments, electric power receiver 120 includes a storage sensor 164, coupled to storage device 126. Storage sensor 164 is configured to sense the amount of electric power stored in storage device 126 and to compare it to a preset level. If the stored power exceeds the preset level, storage sensor 164 induces receiver handshake block 151 to transmit a “storage device full” feedback signal to transmitter handshake block 154. Transmitter handshake block 154 reports the received “storage device full” feedback signal to control circuit 155 of electric power transmitter 110. Electric power transmitter 110 in response may reduce or interrupt the electric power transmission.

In embodiments, electric power receiver 120 includes one or more load sensors 167, coupled to the output voltage terminals V1, V2, and V3. Load sensor 167 senses the load at the output voltage terminals and compares it to a preset level. If the load falls below the preset level, e.g. because the device coupled to the output voltage terminal is switched off, load sensor 167 induces receiver handshake block 151 to transmit a “device switched off” feedback signal to transmitter handshake block 154. Transmitter handshake block 154 reports the received “device switched off” feedback signal to control circuit 155 of electric power transmitter 110. Electric power transmitter 110 in response may reduce or interrupt the electric power transmission.

In some embodiments, the communication between electric power transmitter 110 and electric power receiver 120 is reciprocal, as transmitter handshake block 154 emits signals and receiver handshake block 151 receives the emitted signals. These signals can be control signals, used for the management of the power transmission. For example, if the power transmission is about to experience an interruption, the control signals may send the message to electric power receiver 120 to switch to powering the output voltage terminals from storage device 126.

In embodiments electric power receiver 120 is movable. There are many possible applications, where this is the case. For example, electric power receiver 120 can be part of a movable electric device, such as a projector in an office building, a moving machine in an industrial plant, or a laptop in a residential application. Or electric power receiver 120 can be part of a reconfigurable office design, where office cubicles are repeatedly reconfigured and the devices need access to power after each reconfiguration without waiting for laying down new electric wiring. In these embodiments electric power transmitter 110 is configured to modify the direction of the transmitted power beam in response to a sensed movement of electric power receiver 120.

Different embodiments sense the movement differently. In some embodiments electric power receiver 120 includes a motion sensor 169, which senses a movement of electric power receiver 120. Motion sensor 169 can be of many types, including a gyroscope, a tube arrangement filled with mercury capable of making electrical contacts upon movement, or a piezoelectric apparatus. When motion sensor 169 senses a motion of electric power receiver 120, it induces receiver handshake block 151 to transmit a “receiver movement” feedback signal to transmitter handshake block 154. In some embodiments the “receiver movement” feedback signal contains specific aspects of the sensed movement, such as its direction and speed. In other embodiments the “receiver movement” feedback signal is sent in regular intervals, e.g. in milliseconds or in seconds, to update the movement information, akin to a beacon. When transmitter handshake block 154 receives the “receiver movement” signal, it reports it to control circuit 155. In response, control circuit 155 orders the adjusting of the direction of the transmitted electric power beam so as to keep the transmitted beam aimed at the moving electric power receiver 120. In these embodiments the transmitted beam tracks the movement of electric power receiver 120.

In other embodiments, electric power transmitter 110 includes a bi-directional tracking beam device. A function of the tracking beam device is to target the location and the motion of electric power receiver 120. For example, the tracking beam device can be an infrared sensor, which emits infrared beams and records the reflected beam. Or it can be a low intensity laser beam, or it can be a beacon-signal receiver. In the latter case a beacon is included in electric power receiver 120, whose signal the beacon-signal receiver is tracking. In all of these embodiments, the tracking beam device tracks the movement of electric power receiver 120 and reports the tracked movement to control circuit 155 of electric power transmitter 110. In response, control circuit 155 orders electric power transmitter 110 to adjust the direction of the transmitted electric power beam to keep the transmitted beam aimed at the moving electric power receiver 120.

Although the present invention and its advantages have been described in detail, it should be understood that various changes, substitutions, and alterations can be made therein without departing from the spirit and scope of the invention as defined by the appended claims. That is, the discussion included in this application is intended to serve as a basic description. It should be understood that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Neither the description nor the terminology is intended to limit the scope of the claims.

What is claimed is:

1. An electrical power transmission system, comprising
an electric power transmitter, configured for a wireless transmission of electric power in a confined space; and
an electric power receiver, configured to receive the transmitted electric power in the confined space and to transform the received electric power to power electric devices, wherein
the system is configured to operate substantially free of exposure hazards.

2. The system of claim 1, wherein the system is configured to operate substantially free of exposure hazard by transmitting the electric power with a power flux corresponding to Federal Health Regulations.

3. The system of claim 1, wherein the power flux is less or equal to 5 mW/cm².

4. The system of claim 1, wherein the transmitted power is in the range of 1 W-100 kW.

5. The system of claim 1, wherein the distance between the electric power transmitter and the electric power receiver is in the range of 1 m-100 m.

6. The system of claim 1, wherein
the electric power transmitter comprises a transmitter antenna, having a transmitter antenna diameter; and
the electric power receiver comprises a receiver antenna, having a receiver antenna diameter, wherein
the values of the transmitter antenna diameter and receiver antenna diameter are related to a distance of the transmitter antenna and the receiver antenna and to a wavelength of the transmission.

7. The system of claim 6, wherein
the product of the transmitter diameter and the receiver diameter corresponds to the product of the distance between the transmitter antenna and the receiver antenna and to the wavelength of the transmission.

8. The system of claim 1, wherein the electric power transmitter is configured to transmit the electric power with a frequency in the range of 1 GHz-100 GHz.

9. The system of claim 1, wherein
the electric power transmitter is configured to emit a directed beam; and
the electric power receiver is configured to receive the emitted directed beam in the far field region.

10. The system of claim 1, wherein
the electric power transmitter is configured to emit a coherent directed beam; and
the electric power receiver is configured to receive the emitted coherent directed beam.

11. The system of claim 10, wherein the coherent beam is one of a coherent microwave beam and an infrared laser beam.

12. The system of claim 1, the electric power receiver comprising
a rectifying antenna, configured:
to receive the transmitted electric power; and
to rectify the received electric power.

13. The system of claim 12, the electric power receiver comprising
a storage device, coupled to the rectifying antenna, configured to store the rectified electric power.

14. The system of claim 13, the storage device comprising
at least one of a battery and a capacitor.

15. The system of claim 13, the receiver comprising
a DC-to-DC converter, configured to convert the stored electric power into one or more DC electric voltage.

16. The system of claim 1, wherein the system operates substantially free of exposure hazards by being configured for active power transmission management.

17. The system of claim 16, the system being configured for active power transmission management by comprising:
a receiver handshake block in the electric power receiver, configured to transmit a feedback signal to the electric power transmitter; and
a transmitter handshake block in the electric power transmitter, configured to receive the transmitted feedback signal from the receiver handshake block.

18. The system of claim 17, wherein
the electric power receiver comprises a power sensor to sense a reduction of the transmitted electric power below a predetermined level;
the receiver handshake block is configured to transmit a “reduced power” feedback signal to the transmitter handshake block in response to the sensed reduced transmitted power; and
the electric power transmitter comprises a control circuit to one of reduce and interrupt the electric power transmission in response to the transmitter handshake block receiving a “reduced power” feedback signal.

19. The system of claim 17, wherein the electric power receiver comprises:
a storage device, configured to store the received electric power; and
a storage sensor, coupled to the storage device, configured to sense the amount of electric power stored in the storage device exceeding a predetermined level.

20. The system of claim 19, wherein
the receiver handshake block is configured to transmit a “storage device full” feedback signal to the transmitter handshake block in response to the storage sensor sensing of the stored electric power exceeding the predetermined level; and
the electric power transmitter comprises a control circuit to one of reduce and interrupt the electric power transmission in response to the transmitter handshake block receiving the “storage device full” feedback signal.

21. The system of claim 17, wherein
the electric power receiver comprises a load sensor to sense a reduction of an output load below a predetermined level;
the receiver handshake block is configured to transmit a “device switched off” feedback signal to the transmitter handshake block in response to the load sensor sensing a reduction of an output load below the predetermined level; and
the electric power transmitter comprises a control circuit to one of reduce and interrupt the electric power transmission in response to the transmitter handshake block receiving the “device switched off” feedback signal.

22. The system of claim 17, wherein
the transmitter handshake block comprises a control signal source, configured to emit control signals to the electric power receiver; and
the receiver handshake block comprises a control signal receiver, configured to receive the emitted control signals.

23. The system of claim 16, the system being configured for active power transmission management by the electric power transmitter comprising:
a reflection sensor, configured:
to sense a reflected portion of the transmitted electric power when one of a human and an object is present in a path of the power transmission; and
to report the sensed reflection to a control circuit of the electric power transmitter, wherein
the control circuit is configured to one of reduce and interrupt the electric power transmission in response to the reported sensed reflection.

24. The system of claim 16, the system being configured for active power transmission management by comprising:
a “transmission path clear” signal source in the electric power receiver, configured to emit a “transmission path clear” signal to the electric power transmitter.

25. The system of claim 24, the system being configured for active power transmission management by comprising:
a “transmission path clear” signal receiver in the electric power transmitter, configured:
to receive the “transmission path clear” signal; and
to report the received signal to a control circuit, wherein
the control circuit is configured to one of reduce and interrupt the electric power transmission when the “transmission path clear” signal is not received from the “transmission path clear” signal source.

26. The system of claim 1, wherein
the electric power receiver is movable; and
the electric power transmitter is configured to modify a direction of a transmitted power beam in response to a sensed movement of the electric power receiver.

27. The system of claim 26, wherein
the electric power receiver comprises a motion sensor, configured to sense a movement of the electric power receiver;
the receiver handshake block is configured to transmit a “receiver movement” feedback signal to the transmitter handshake block upon sensing the movement of the electric power receiver; and
the electric power transmitter is configured to adjust a direction of a transmitted electric power beam in response to the transmitter handshake block receiving the “receiver movement” feedback signal.

28. The system of claim 27, wherein
the electric power transmitter is configured to adjust the direction of the transmitted electric power beam to track the motion of the electric power receiver.

29. The system of claim 26, the electric power transmitter comprising
a tracking beam device, configured:
to target a location of the electric power receiver;
to track a motion of the electric power receiver; and
generate a tracking signal for the electric power transmitter; wherein
the electric power transmitter is configured to adjust a direction of a transmitted electric power beam in response to the tracking signal.

30. An electrical power transmission system, comprising
an electric power transmitter, configured for a wireless transmission of electric power in a confined space; and
an electric power receiver, configured to receive the transmitted electric power in the confined space, the electric power receiver comprising:
a rectifier, configured to rectify the receiver electric power;
a storage device, coupled to the rectifier, configured to store the rectified electric power; and
a power controller, coupled to the storage device, configured to produce one or more regulated outputs, wherein
the electric power transmitter is configured to transmit electric power with a power flux corresponding to Federal Health Regulations.

31. An electrical power transmission system, comprising
an electric power transmitter, configured for a wireless transmission of electric power in a confined space; and
an electric power receiver, configured to receive the transmitted electric power in the confined space, the electric power receiver comprising:
a rectifier, configured to rectify the receiver electric power;
a storage device, coupled to the rectifier, configured to store the rectified electric power;
a power controller, configured to produce one or more regulated outputs; and
a feedback transmitter, configured to transmit a feedback signal to the electric power transmitter, wherein
the electric power transmitter comprises
a feedback receiver, configured to receive the transmitted feedback signal from the electric power receiver.

32. A method of transmitting electric power, the method including the steps of:
transmitting electric power wirelessly in a confined space with a power flux corresponding to Federal Health Regulations;
receiving the transmitted electric power; and
transforming the received electric power into a form suitable for powering electric devices.

33. The method of claim 32, comprising
transmitting electric power wirelessly inside a building with a power flux less or equal 5 mW/cm².

34. The method of claim 32, comprising
generating a feedback signal according to an operating condition of the receiver; and
modifying the transmission of the electric power in response to the feedback signal.

35. The method of claim 34, wherein
the operating condition is one of a: “reduced power” condition, a “storage device full” condition, and a “device switched off” condition; and
the modifying step comprises one of a reducing and an interrupting of the transmitted electric power.

36. The method of claim 34, wherein
the operating condition is a “receiver movement” condition; and
the modifying step comprises modifying a direction of the transmitted beam according to the feedback signal.

37. The method of claim 36, wherein
the modifying step comprises tracking a movement of an electric power receiver.
